(19) United States
(12) Patent Application Publication
(10) Pub. No.: US 2008/0152980 A1
(43) Pub. Date: Jun. 26, 2008

(54) MEMBRANE ELECTRODE ASSEMBLY, METHOD OF PRODUCING THE MEMBRANE ELECTRODE ASSEMBLY, AND FUEL CELL USING THE MEMBRANE ELECTRODE ASSEMBLY

(75) Inventor: Akiyoshi Yokoi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/950,374

(22) Filed: Dec. 4, 2007

(30) Foreign Application Priority Data
Dec. 21, 2006 (JP) 2006-344269

(51) Int. Cl. H01M 8/10; B29C 65/00; H01M 4/88

(52) U.S. Cl. 429/30; 156/196; 156/227; 29/2; 29/746

(57) ABSTRACT

The invention can provide a membrane electrode assembly having a high degree of freedom in disposing electrodes, few assembly steps, and a small number of components, and reliably reducing leakage of hydrogen in a plane-configuration fuel cell. The invention can further provide a method of manufacturing the membrane electrode assembly and the fuel cell using the membrane electrode assembly. This is made possible by forming a structure in which, by deforming the membrane electrode assembly having the electrodes formed on both surfaces thereof, the electrodes on both surfaces are electrically connected to each other in series.

### BACKGROUND OF THE INVENTION

1. Field of the Invention

The present invention relates to a membrane electrode assembly, a method of producing the membrane electrode assembly, and a fuel cell using the membrane electrode assembly.

2. Description of the Related Art

A fuel cell system can supply an energy amount per volume that is approximately from a few times to 10 times the energy amount per volume than a related cell can supply. In addition, by continuously filling the fuel cell system with fuel, the fuel cell system makes it possible for a small electronic apparatus, such as a notebook computer or a cellular phone, to be continuously used for a long time. Therefore, the fuel cell system is being considered as a promising system.

In a fuel cell, a fuel electrode having a catalyst and an oxidizer electrode having a catalyst are disposed on opposite surfaces of an electrolyte membrane, so that one fuel cell unit is formed. The fuel cell supplies fuel, such as hydrogen gas (stored in, for example, a hydrogen storing alloy tank) towards the fuel electrode, and supplies an oxidizer, such as oxygen, towards the oxidizer electrode. Then, reactants thereof are made to electrically and chemically react through the electrolyte membrane, so that the fuel cell generates electrical power.

Electromotive force of a fuel cell unit is approximately 1 V. Therefore, in correspondence with load characteristics of an apparatus, a plurality of fuel cell units are electrically connected in series, to increase voltage.

Methods of disposing fuel cell units, such as a method of stacking fuel cell units in accordance with the form of an apparatus and a method of disposing a plurality of electrodes in plane configuration on an electrolyte membrane, have been proposed.

Japanese Patent Laid-Open No. 2003-197225 (US 2004/0086762) discloses a technology of obtaining a high voltage while maintaining the thinness of a fuel cell by electrically connecting in series a plurality of fuel cell units, provided in a plane, using a through-hole or a bump connection.

Japanese Patent Laid-Open No. 2003-317790 discloses a technology of increasing voltage as a result of electrically connecting in series a plurality of cylindrical fuel cell units by superposing the fuel cell units upon each other and joining opposite electrodes.

The technology discussed in Japanese Patent Laid-Open No. 2003-197225 has a problem in that the number of parts is increased due to the necessity of using conductive members extending through an electrolyte membrane and members sealing the vicinity of the conductive members.

In the technology discussed in Japanese Patent Laid-Open No. 2003-317790, in one joining step, electrodes on a pair of joining surfaces can only be connected to each other. Therefore, the number of joining steps required is substantially the same as the number of connections in series, as a result of which the number of required manufacturing steps is increased. In addition, when the number of joining locations is increased, it becomes difficult to ensure the reliability of a product.

### SUMMARY OF THE INVENTION

The present invention is directed to providing a membrane electrode assembly which makes it possible to electrically connect in series, using a few steps, electrodes of a plurality of fuel cell units formed on two surfaces of an electrolyte membrane; and is also directed to providing a fuel cell using the membrane electrode assembly. The present invention is also directed to a membrane electrode assembly having high reliability due to a fewer number of sealing locations, and to a fuel cell using the membrane electrode assembly.

The present invention provides a membrane electrode assembly, wherein the membrane electrode assembly includes a common electrolyte membrane having a first surface and a second surface opposite to the first surface, and a plurality of fuel cell units disposed side by side on the electrolyte membrane. Each fuel cell unit has a first electrode on the first surface and a second electrode on the second surface. In addition, a first electrode of a first cell is electrically connectable to a second electrode of a second cell as a result of folding or bending an end portion of the electrolyte membrane. The present invention also provides a method of manufacturing the membrane electrode assembly, and a fuel cell using the membrane electrode assembly.

Further, the present invention provides a membrane electrode assembly, wherein the membrane electrode assembly includes a common electrolyte membrane having a first surface and a second surface opposite to the first surface, and a plurality of fuel cell units disposed side by side on the electrolyte membrane. Each fuel cell unit has a first electrode on the first surface and a second electrode on the second surface. In addition, the electrolyte membrane has a through hole, and a first electrode of a first cell is electrically connectable to a second electrode of a second cell through the through hole as a result of folding the electrolyte membrane. Still further, the present invention provides a method of manufacturing the membrane electrode assembly, and a fuel cell using the membrane electrode assembly.

According to the present invention, the electrodes can be connected to each other using a few steps, and the number of sealing locations is reduced. Therefore, the present invention can provide a highly reliable membrane electrode assembly and a fuel cell using the membrane electrode assembly.

Further features of the present invention will become apparent from the following description of exemplary embodiments with reference to the attached drawings.

### BRIEF DESCRIPTION OF THE DRAWINGS

FIG. 1 is a schematic perspective view illustrating the structure of a membrane electrode assembly.

FIG. 2 illustrates a state in which a fuel cell system is mounted to a housing of an electronic apparatus.

FIG. 3 illustrates a state in which the fuel cell system is mounted to the housing of the electronic apparatus.

FIG. 4 illustrates the structure of a fuel cell unit of the fuel cell system.

FIG. 5 is a block diagram of the electronic apparatus to which the fuel cell system is mounted.

FIG. 6 illustrates a state of operation of the fuel cell unit.

FIG. 7 is a schematic perspective view illustrating the structure of a surface of the membrane electrode assembly where oxidizer electrodes are formed.

FIG. 8 is a schematic perspective view illustrating the structure of a surface of the membrane electrode assembly where fuel electrodes are formed.

FIG. 9 is a schematic perspective view illustrating a method of manufacturing the membrane electrode assembly.

FIG. 10 is a schematic perspective view illustrating the method of manufacturing the membrane electrode assembly.

FIG. 11 is a schematic perspective view illustrating the method of manufacturing the membrane electrode assembly.

FIG. 12 is a circuit diagram illustrating electrical connection of the membrane electrode assembly.

FIG. 13 is a schematic perspective view illustrating the structure of a fuel cell.

FIG. 14 is a schematic perspective view illustrating the structure of the fuel cell.

FIG. 15 is a schematic perspective view illustrating the structure of the fuel cell.

FIG. 16 is a schematic view illustrating a fuel cell unit of a fuel cell according to a second embodiment.

FIG. 17 is a schematic perspective view illustrating the structure of a surface of a membrane electrode assembly where oxidizer electrodes are formed according to the second embodiment.

FIG. 18 is a schematic perspective view illustrating the structure of a surface of the membrane electrode assembly where fuel electrodes are formed according to the second embodiment.

FIG. 19 is a schematic perspective view illustrating the structure of a separator according to the second embodiment.

FIG. 20 is a schematic perspective view illustrating the structure of the separator according to the second embodiment.

FIG. 21 is a schematic perspective view illustrating the structure of the fuel cell according to the second embodiment.

FIG. 22 is a schematic perspective view illustrating the structure of a membrane electrode assembly according to a third embodiment.

FIG. 23 is a schematic perspective view illustrating a surface of the membrane electrode assembly where oxidizer electrodes are formed according to a fourth embodiment.

FIG. 24 is a schematic perspective view illustrating a surface of the membrane electrode assembly where fuel electrodes are formed according to the fourth embodiment.

FIG. 25 is a schematic perspective view illustrating a method of manufacturing the membrane electrode assembly according to the fourth embodiment.

FIG. 26 is a schematic perspective view illustrating the method of manufacturing the membrane electrode assembly according to the fourth embodiment.

FIG. 27 is a schematic perspective view illustrating the method of manufacturing the membrane electrode assembly according to the fourth embodiment.

FIG. 28 is a schematic perspective view illustrating the method of manufacturing the membrane electrode assembly according to the fourth embodiment.

### DESCRIPTION OF THE EMBODIMENTS

A fuel cell system 1 according to an embodiment of the present invention will now be described in detail with reference to the drawings.

The structure of a fuel cell system according to the present invention is not limited to the structure of the fuel cell system 1 described below. Accordingly, the fuel cell system 1 according to the present invention can be realized in accordance with other embodiments, in which part of or the entire structure of the fuel cell system 1 is replaced by another structure. For example, although the entire fuel cell system 1, in which a fuel cell 2 and a fuel tank 6 are integrally connected to each other, is removable from an electronic-apparatus housing 11, the fuel tank 6 alone can be removable from the electronic-apparatus housing 11 as a result of installing the fuel cell 2 in the electronic-apparatus housing 11.

Although, in the embodiment below, oxygen in the atmosphere will be obtained and used as an oxidizer, other gaseous materials or liquid materials which can be oxidized may be used as the oxidizer. When oxygen is used as the oxidizer, instead of obtaining it from the atmosphere, an oxygen-gas cylinder or an oxygen-gas generating unit (not shown) may be connected to the fuel cell 2 to supply the oxygen therefrom.

Although, in the description, the present invention is applied to a fuel cell 2 using hydrogen gas as fuel, the present invention may be applied to fuel batteries using other types of fuel (such as methanol or ethanol), to obtain similar advantages.

### First Embodiment

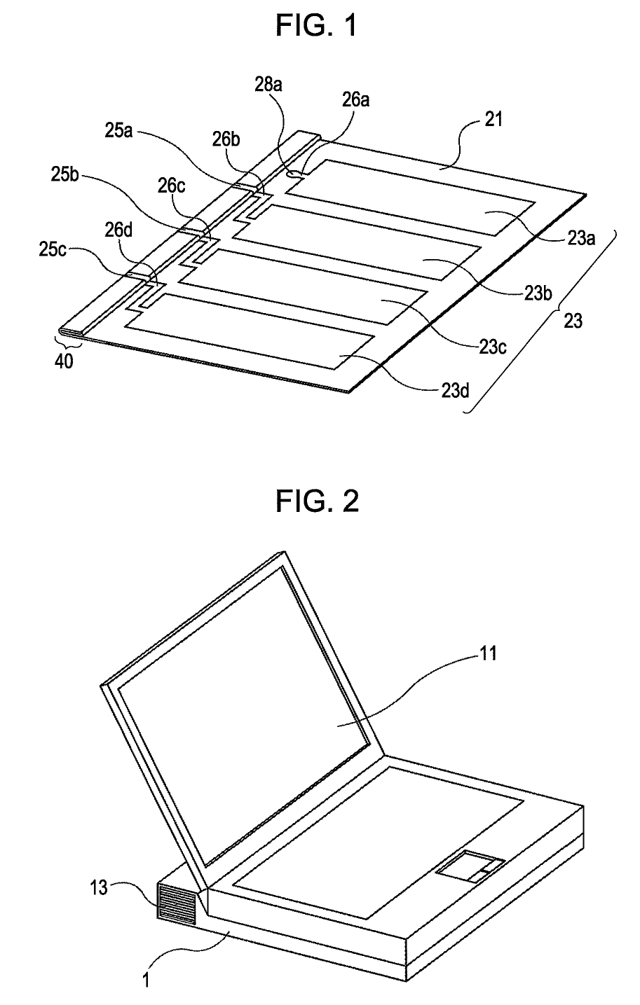

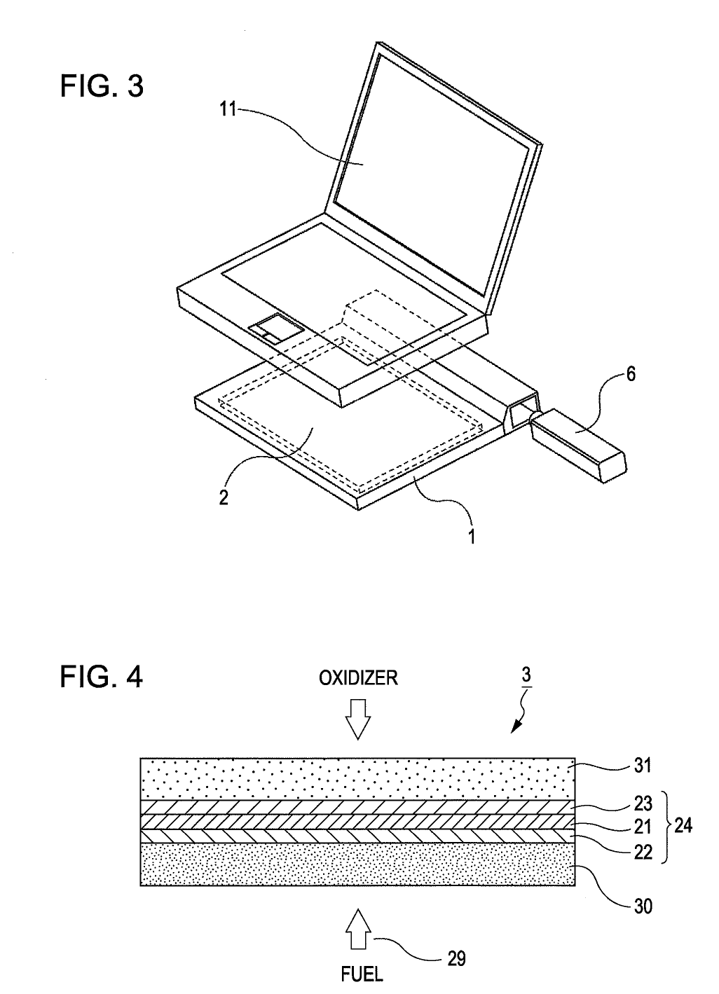

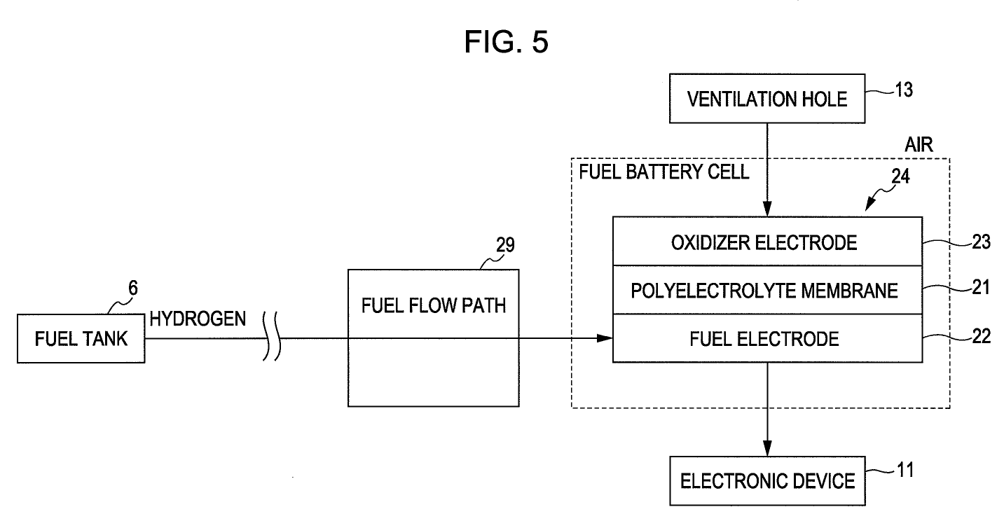

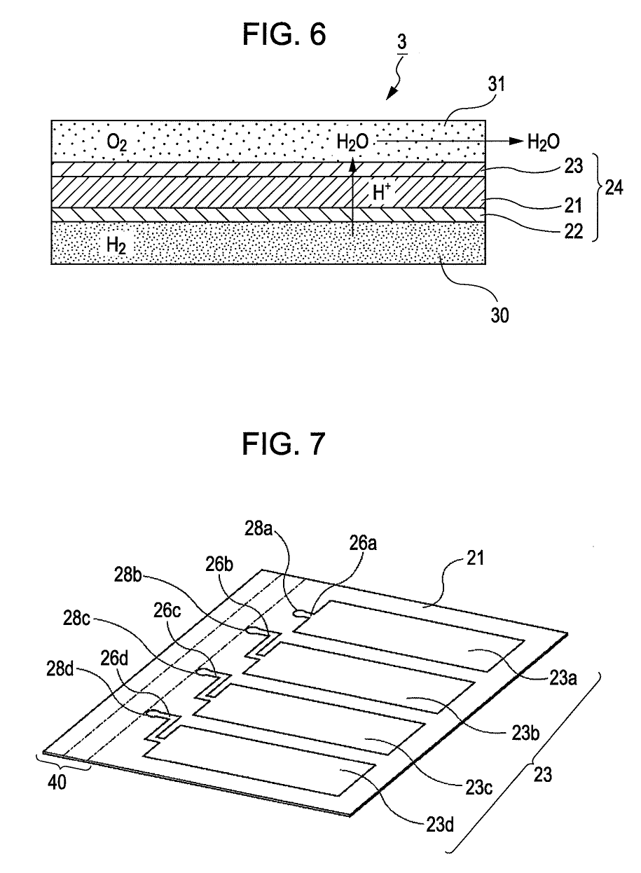

FIG. 1 is a schematic view illustrating the structure of a membrane electrode assembly according to the present invention. FIGS. 2 and 3 illustrate a state in which a fuel cell system is mounted to a housing of an electronic apparatus. FIG. 4 is a schematic sectional view illustrating the structure of a fuel cell unit of the fuel cell system. FIG. 5 is a block diagram of the fuel cell system. FIG. 6 is a schematic sectional view illustrating a state of operation of the fuel cell unit.

As shown in FIG. 2, the fuel cell system 1 is removably mounted to the lower portion of the housing of the electronic apparatus (notebook computer) 11. Ventilation holes 13 for supplying an oxidizer (oxygen in the atmosphere) to the fuel cell system 1 is provided in the housing of the electronic apparatus 11. As shown in FIG. 3, the fuel cell 2 (described later) is incorporated in the interior of the fuel cell system 1, and supplies fuel from the removable fuel tank 6.

As shown in FIGS. 4 and 5, the fuel cell 2 includes, as a structural element, a fuel cell unit 3 that takes out electrical current as a result of causing hydrogen gas to electrically and chemically react with oxygen. The fuel cell unit 3 comprises a membrane electrode assembly 24 interposed between an oxidizer-electrode side diffusion layer 31 and a fuel-electrode side diffusion layer 30. The oxidizer-electrode side diffusion layer 31 is used to supply an oxidizer and to discharge water vapor. The fuel-electrode side diffusion layer 30 is used to supply hydrogen gas as fuel. The fuel-electrode side diffusion layer 30, used to supply the hydrogen gas to its corresponding fuel cell unit 3, communicates with a fuel flow path 29. The fuel flow path 29 communicates with the fuel tank 6.

The fuel-electrode side diffusion layer 30 is formed of porous material, and diffuses and supplies hydrogen gas molecules to the entire surface of a fuel electrode 22 of the membrane electrode assembly 24. The oxidizer-electrode side diffusion layer 31 is also formed of porous material. The oxidizer-electrode side diffusion layer 31 diffuses and supplies oxygen gas molecules to the entire surface of an oxidizer electrode 23 of the membrane electrode assembly 24, and diffuses and discharges water vapor that is generated to the outside of the fuel cell system 1.

As shown in FIG. 6, the membrane electrode assembly 24 is formed so that a polymer electrolyte member 21 is interposed between the fuel electrode 22 and the oxidizer electrode 23. The fuel electrode 22 is a porous thin-film layer in which a platinum catalyst is diffused. The fuel electrode 22 decomposes hydrogen gas into hydrogen molecules, ionizes the hydrogen molecules, and sends the hydrogen ions to the polymer electrolyte member 21.

The oxidizer electrode 23 is a porous thin-film layer in which a platinum catalyst is diffused. The oxidizer electrode 23 causes the hydrogen ions that it has received from the polymer electrolyte member 21 to react with oxygen gas, to generate water molecules. The polymer electrolyte member 21 causes the hydrogen ions that it has received from the fuel electrode 22 to move, transfers them to the oxidizer electrode 23, and prevents direct electron movement between the fuel electrode 22 and the oxidizer electrode 23.

As indicated by the arrow in FIG. 5, hydrogen gas, serving as fuel, stored in the fuel tank 6 is supplied to the fuel electrode 22 through the fuel flow path 29. In contrast, oxygen in the atmosphere, obtained from the ventilation holes 13, is supplied to the oxidizer electrode 23.

The hydrogen gas passes through the diffusion layer 30, penetrates the fuel electrode 22, contacts the catalyst in the fuel electrode 22, and is ionized. The hydrogen ions pass through the polymer electrolyte member 21. In contrast, the oxygen that is obtained from the atmosphere passes through the diffusion layer 31. Then, under the presence of catalyst molecules included in the oxidizer electrode 23, the oxygen combines with the hydrogen ions that have passed through the polymer electrolyte member 21, so that water molecules are generated.

Such an electrical and chemical reaction causes electrons of the hydrogen molecules to be removed from the fuel electrode 22, and to be guided to the oxidizer electrode 23 through an external electrical circuit (not shown), so that water molecules are generated. In this process, electrical power corresponding to energy resulting from subtracting, for example, internal resistance or heat energy generated due to electrical and chemical differences in energy is taken out to the external electrical circuit. Membrane electrode assembly

A method of manufacturing the membrane electrode assembly 24 will be described.

As shown in FIG. 1, in accordance with the load of the electronic apparatus 11, the fuel electrode 22 and the oxidizer electrode 23 of a plurality of fuel cell units 3 are disposed on the common polymer electrolyte member 21; and, as described below, are electrically connected in series by wiring electrodes 25 and 26. Although, in the embodiment, four fuel cell units 3 are connected to each other, any suitable and predetermined number of fuel cell units may be connected and used in accordance with the intended purpose and the operating environment.

As shown in FIG. 7, oxidizer electrodes 23a to 23d of the respective fuel cell units 3 are formed on one surface of the polymer electrolyte member 21. In addition, from the respective oxidizer electrodes, wiring electrodes 26a to 26d of electrical wires, and contact electrodes 28a to 28d, disposed at ends of the respective wiring electrodes 26a to 26d, are formed to a fold portion 40 (described later).

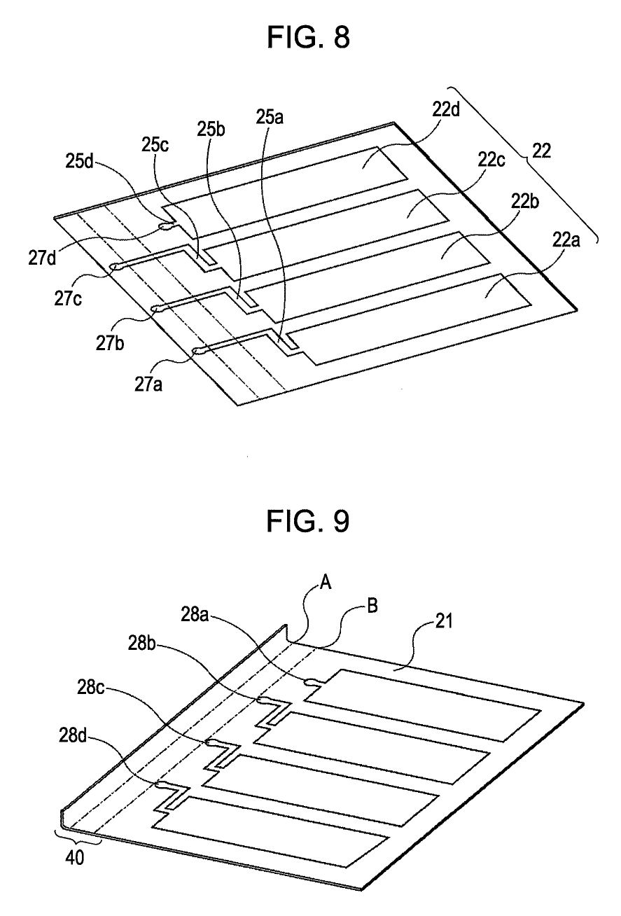

As shown in FIG. 8, at the surface of the polymer electrolyte member 21 that is opposite to the surface where the oxidizer electrodes are formed, fuel electrodes 22a to 22d are formed so as to counter the oxidizer electrodes 23a to 23d. In addition, from the respective fuel electrodes, wiring electrodes 25a to 25d and contact electrodes 27a to 27d, disposed at ends of the respective wiring electrodes 25a to 25d, are formed to the fold portion 40 (described later).

The fuel electrode 22, the oxidizer electrode 23, the wiring electrodes 25 and 26, and the contact electrodes 27 and 28 are formed as follows. Pt-bearing carbon particles, formed into a paste as a result of adding a polymer electrolyte, is applied to the polymer electrolyte member 21 by, for example, a doctor blade method or a screen printing method. After drying the applied paste, the polymer electrolyte member 21 is welded to the fuel electrode 22, the oxidizer electrode 23, the wiring electrodes 25 and 26, and the contact electrodes 27 and 28 by hot pressing, so that the membrane electrode assembly 24 is manufactured.

The method of forming the electrodes is not limited to hot pressing, so that they may be formed on the polymer electrolyte member 21 by, for example, sputtering, evaporation, or plating. Although the wiring electrodes 25 and 26, and the contact electrodes 27 and 28 are described as being formed of Pt-bearing carbon particles as with the fuel electrode 22 and the oxidizer electrode 23, they do not need to be formed of the same material as the fuel electrode 22 and the oxidizer electrode 23, as long as they are formed of a material having low electrical resistance. For example, they may be formed by placing a general electrical-wire material, such as copper or gold, onto a Pt-bearing carbon particle layer of the fuel electrode 22 and that of the oxidizer electrode 23, and by performing evaporation. In this case, the electrical resistances of contact portions and the wires can be kept low, so that a fuel cell having little power generation loss can be provided.

At the stage in which the electrodes are formed, the membrane electrode assembly 24 is such that the fuel electrode 22 and the oxidizer electrode 23 of the fuel cell units 3 are not electrically connected to each other.

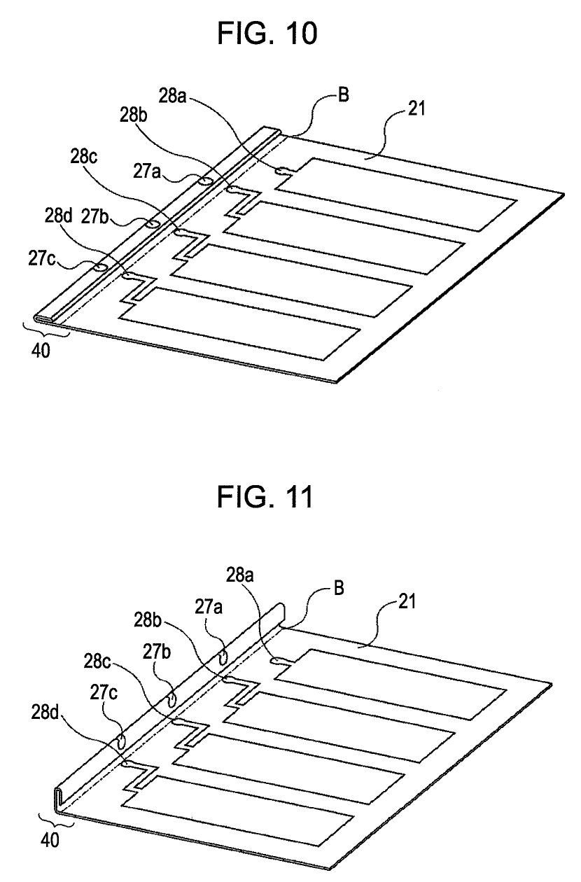

At the next stage, as shown in FIG. 9, with the surface where the contact electrodes 28a to 28d are formed being faced upward, the fold portion 40 at the end portion of the polymer electrolyte member 21 is folded along a first fold line A. By this, as shown in FIG. 10, the contact electrodes 27a to 27c are arranged adjacent to the contact electrodes 28b to 28d, so that the contact electrodes 27 and 28, which are formed on two different sides, are positioned both facing upward.

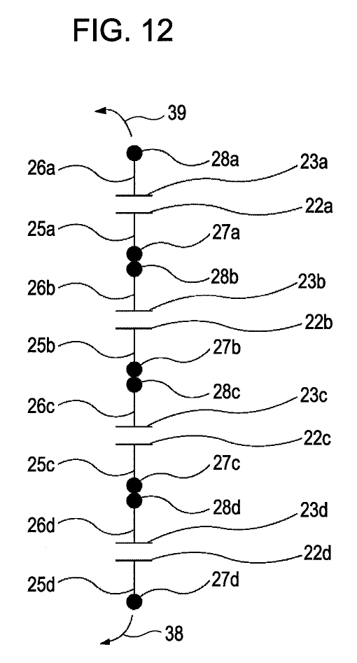

Then, as shown in FIG. 11, the fold portion 40 is folded once again along a second fold line B, so that the portions where the contact electrodes 27a to 27c are formed, oppose the contact electrodes 28b to 28d. As a result, the membrane electrode assembly 24 is finally formed into a state such as that shown in FIG. 1. The contact electrodes are previously patterned and disposed so that, when the contact electrodes 27a and 28b, the contact electrodes 27b and 28c, and the contact electrodes 27c and 28d are folded, they oppose each other at the fold portion 40. Therefore, an electrical circuit diagram becomes like that shown in FIG. 12, so that the fuel electrodes 22 and the oxidizer electrodes 23 of the respective fuel cell units 3 are electrically connected in series.

Next, by hot-pressing the fold portion 40, the portions of the polymer electrolyte member 21 that are folded and placed upon each other are such that opposing sides thereof are welded into an integral structure, as a result of which leakage of, for example, hydrogen gas from the fold portion 40 does not occur. In addition, at the same time, the contact electrodes 27 and 28 that oppose each other are also welded and joined by hot pressing, so that electrical conduction is stably performed. Accordingly, the membrane electrode assembly 24 in which the fuel electrodes and oxidizer electrodes of the respective fuel cell units 3 are connected to each other in series is completed.

Although the structure in which the portions of the fold portion 40 can be welded by hot-pressing as described above, it is possible to adhere the portions of the fold portion 40 with an adhesive. Contacts of the contact electrodes 27 and 28 can also be joined using, for example, solder. In addition, although the fold portion 40 of the polymer electrolyte member 21 is described as being folded towards the oxidizer electrode side, it can be folded towards the fuel electrode side if the pattern structure is changed as appropriate.

### Structure of Fuel Cell

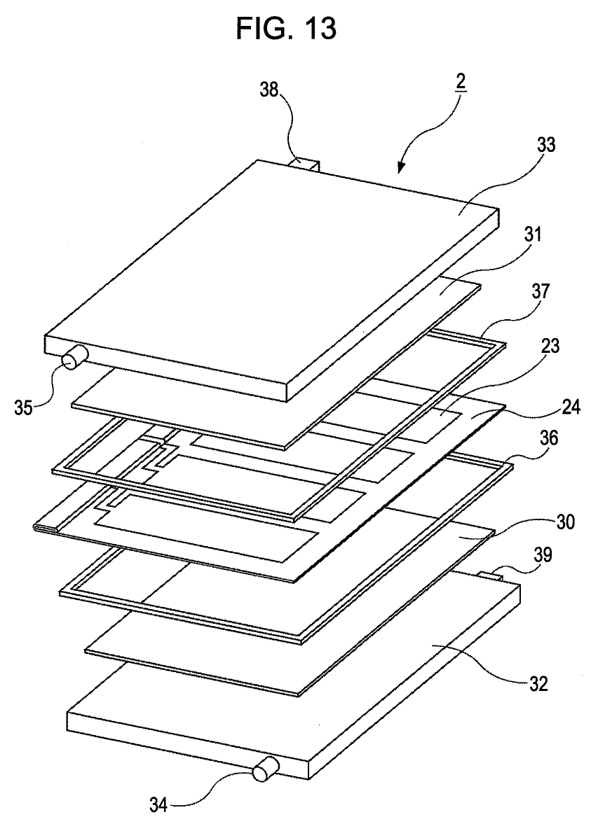

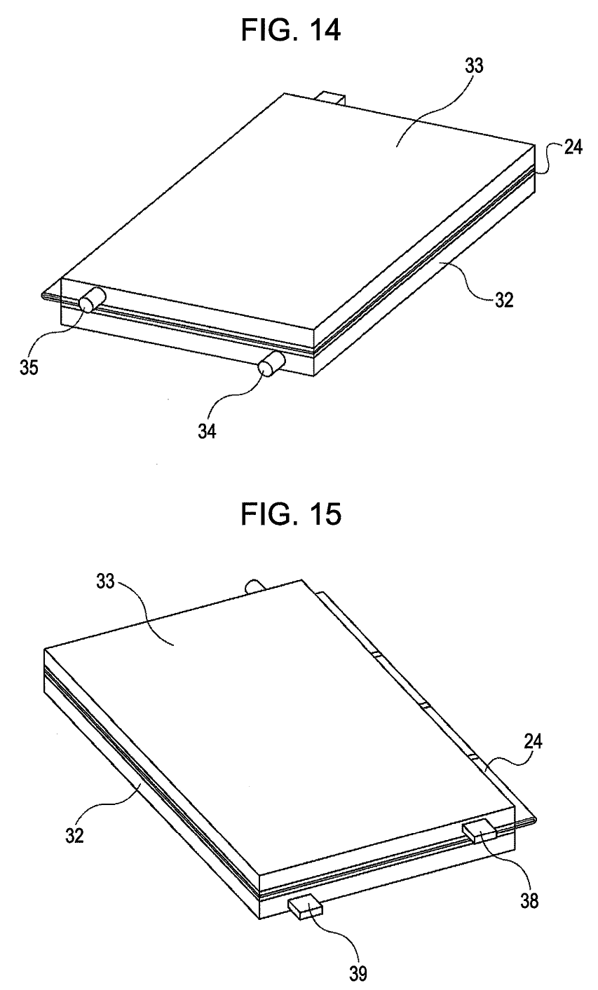

As shown in FIGS. 13, 14, and 15, the fuel cell 2 is assembled by placing the diffusion layers 30 and 31 upon each other at locations corresponding to the locations of the fuel electrode 22 and the oxidizer electrode 23 of the aforementioned membrane electrode assembly 24, sealing the vicinity thereof with seals 36 and 37, and, then, sandwiching the resulting structure with separators 32 and 33. Since the seals 36 and 37 are formed of, for example, flexible fluorine rubber, even if they are positioned upon the wiring electrodes 25 and 26, it is possible to sufficiently prevent leakage of hydrogen. The seals are not limited to resilient seals. Even if, for example, an adhesive is used, a similar sealing performance can be provided.

The separators 32 and 33 are provided with extraction electrodes 39 and 38 at locations corresponding to the contact electrodes 27d and 28a (see FIGS. 12 and 13). The extraction electrodes 38 and 39 are connected to the electronic-apparatus housing 11 from the fuel cell units 3 that are electrically connected in series.

The fuel electrode 22 of the four fuel cell units 3 communicates with the fuel flow path 29 through the diffusion layers 30 thereof. As hydrogen is consumed by the fuel cell 2, hydrogen gas in the fuel tank 6 is supplied to the fuel electrode 22 through a connector 34 of the separator 32 and the diffusion layer 30 of each fuel cell unit 3. Air, serving as an oxidizer, is absorbed through the ventilation holes 13, and is supplied to the diffusion layer 31 of each fuel cell unit 3 through a connector 35 of the separator 33. Then, hydrogen ions and oxygen combine with each other, so that electrical power is supplied to the electronic-apparatus housing 11 that is electrically connected from the extraction electrodes 38 and 39.

The number of fuel cell units 3 that are connected can be freely increased in the direction of arrangement (vertical direction in FIG. 1) of the fuel electrode 22 and the oxidizer electrode 23.

As described above, one membrane electrode assembly 24 can have, as a single component, a structure in which a plurality of fuel cell units 3 are electrically connected in series. Therefore, it is possible to reduce the number of sealing locations compared to that in a structure in which a plurality of components are combined, so that a highly reliable membrane electrode assembly and a fuel cell using the membrane electrode assembly can be provided. In addition, since a plurality of contacts can be joined at the same time at one fold portion, even if the number of fuel cell units to be connected is increased, the number of components and the number of steps are not increased. Therefore, it is possible to provide a highly reliable, low-cost membrane electrode assembly and a fuel cell using the membrane electrode assembly.

### Second Embodiment

A second embodiment of the present invention will now be described.

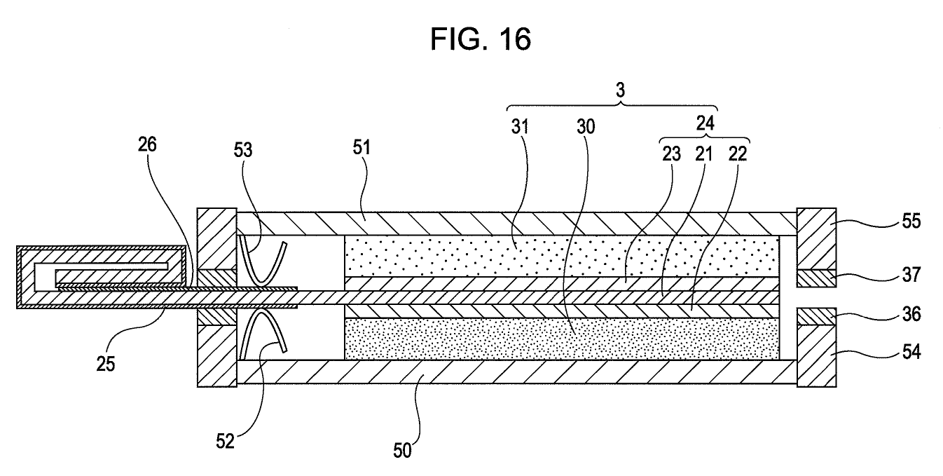

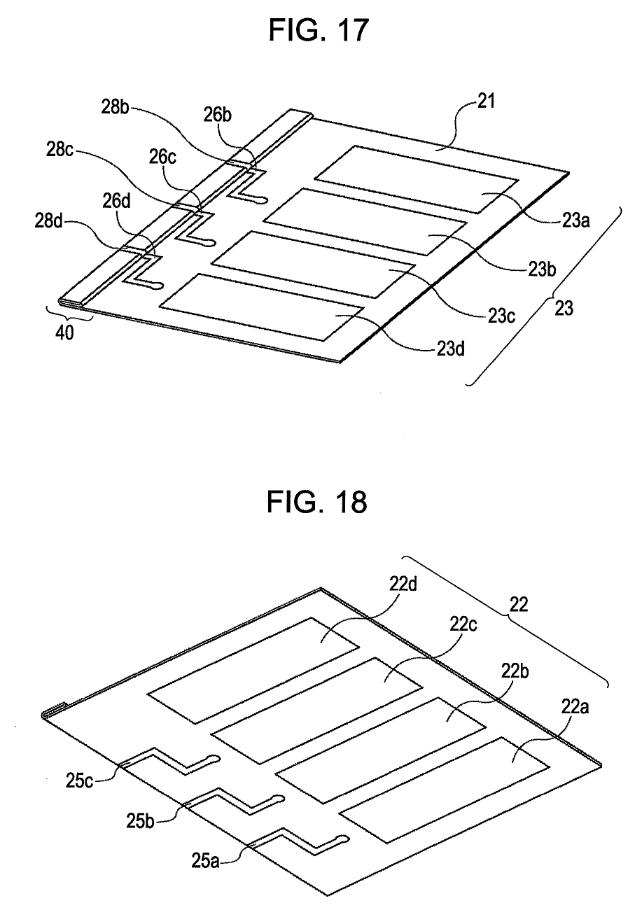

As shown in FIGS. 16, 17, and 18, a fuel electrode 22 and an oxidizer electrode 23 of a membrane electrode assembly 24 are formed so as not to be electrically connected with a wiring electrode 25 and a wiring electrode 26, respectively. As in the first embodiment, the wiring electrodes 25 and 26 on the respective sides are connected to each other by folding an end portion of the membrane electrode assembly 24.

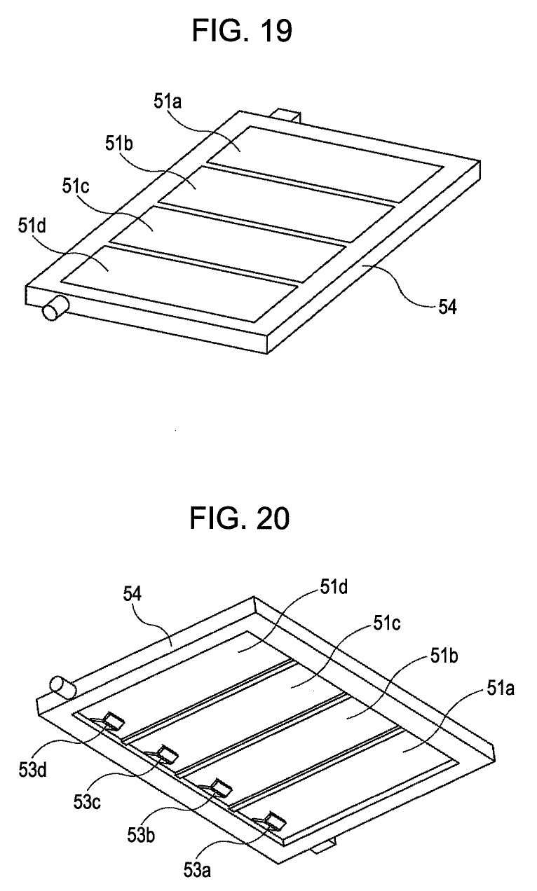

As shown in FIGS. 16, 19 and 20, separators 32 and 33 are such that electrode plates 51 and 50 are divided with the fuel cell units 3, and are supported by separator frames 55 and 54 so that the fuel cell units 3 are not short-circuited. In addition, the electrode plates 51 and 50 are provided with springy electrode-plate contacts 53 and 52, respectively, so that they function as contacts as described below.

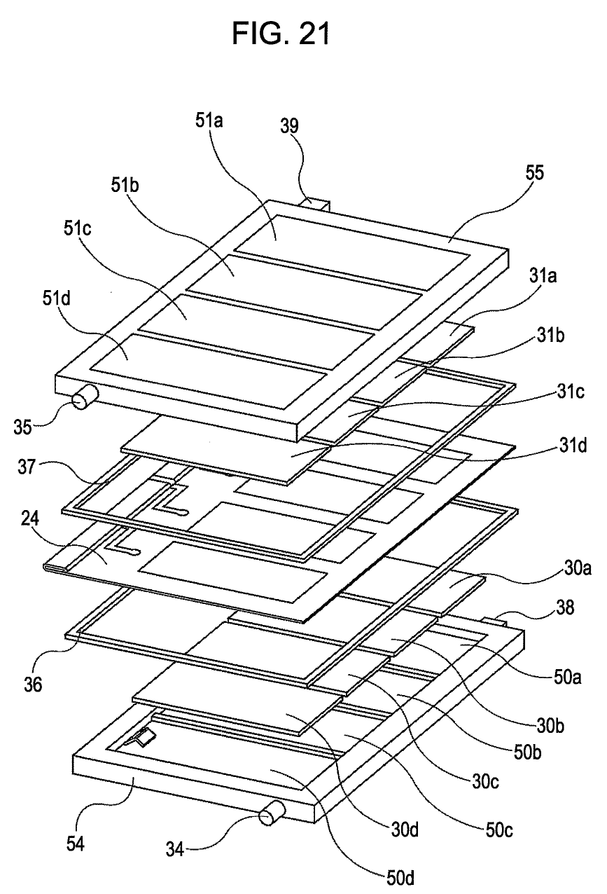

As shown in FIG. 21, a fuel cell 2 is assembled by stacking diffusion layers 30 and 31 (formed of porous electrically conductive material) upon the fuel electrode 22 and the oxidizer electrode 23 of the membrane electrode assembly 24 with the fuel cell units 3. The diffusion layers 30 and 31 are formed of carbon fiber, such as carbon paper or carbon cloth, or a porous metal, such as foam metal.

Then, the separators 32 and 33 having the electrically conductive electrode plates 50 and 51 are stacked upon the respective diffusion layers 30 and 31. The electrode plates 50 and 51 are provided with the springy electrode-plate contacts 52 and 53, so that, when they are stacked, they are electrically connected with the wiring electrodes 25 and 26, respectively, on the membrane electrode assembly 24. In addition, when the fuel cell 2 is assembled, the fuel electrode 22 and the oxidizer electrode 23 of the membrane electrode assembly 24 are electrically connected to the wiring electrodes 25 and 26 through the respective diffusion layers 30 and 31 and the respective electrode plates 50 and 51. At this time, as in the first embodiment, the fuel cell units 3 are connected as shown in FIG. 12.

Accordingly, by connecting the fuel cell units 3 in series through the diffusion layers 30 and 31 and the electrode plates 50 and 51, it is possible to extract electricity from a direction perpendicular to the surface of the fuel electrode 22 and the surface of the oxidizer electrode 23.

Since Pt-bearing carbon particles used in the fuel electrode 22 and the oxidizer electrode 23 have high internal resistance, it is possible to keep the resistance lower by extracting electricity from a direction perpendicular to the surface of the fuel electrode 22 and the surface of the oxidizer electrode 23 than by extracting electricity from a direction parallel to these surfaces. Therefore, compared to the first embodiment in which electrical conduction is performed directly from the end portion of the fuel electrode 22 and the end portion of the oxidizer electrode 23, the second embodiment makes it possible to reduce contact area and wiring resistance, so that power generation loss can be reduced.

### Third Embodiment

A third embodiment of the present invention will now be described.

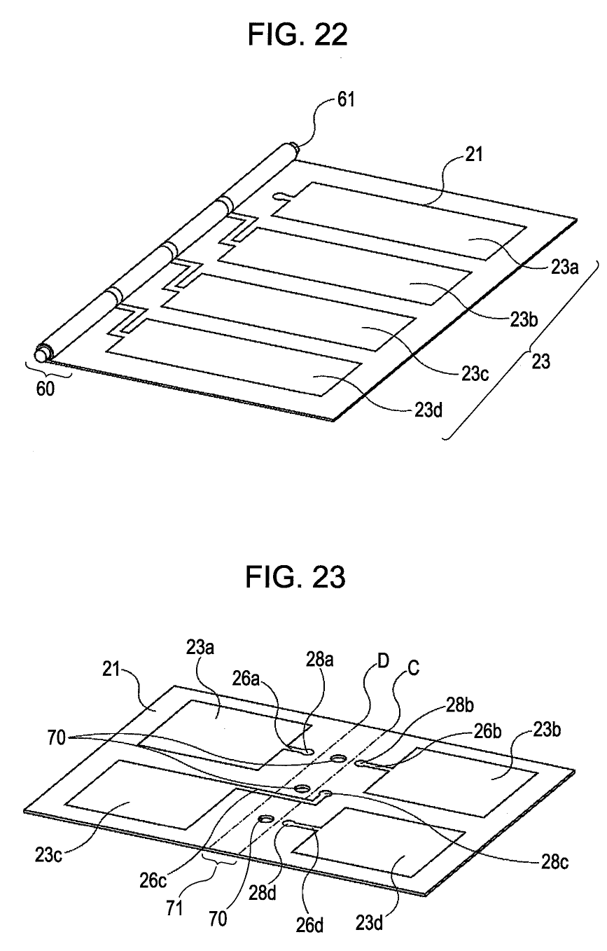

In the first and second embodiments, an end portion of the membrane electrode assembly 24 is folded. In the third embodiment, as shown in FIG. 22, electrical connection between electrodes on the respective surfaces of a polymer electrolyte member 21 is made possible by winding a winding portion 60, disposed at an end of the membrane electrode assembly 24, around a cylindrical member 61 serving as a supporting member.

Even if the fuel cell 2 of each of the first and second embodiments is assembled using the membrane electrode assembly 24 having such a structure, similar advantages are provided.

### Fourth Embodiment

A fourth embodiment of the present invention will now be described.

The fourth embodiment only differs from the first to third embodiments in the method of achieving electrical conduction between each fuel cell unit 3 and a fold portion 71 of a membrane electrode assembly 24. The other structural features are the same.

A method of manufacturing a membrane electrode assembly 24 will be described.

As shown in FIG. 23, oxidizer electrodes 23a to 23d of respective fuel cell units 3 are, in pairs, formed on one surface of a polymer electrolyte member 21. In the fourth embodiment, four fuel cell units 3 are disposed in the form shown in FIG. 23. From the oxidizer electrodes 23a to 23d, wiring electrodes 26a to 26d of electrical wires, and contact electrodes 28a to 28d, formed at ends of the wiring electrodes 26a to 26d, are formed towards a fold portion 71 at the center portion of the polymer electrolyte member 21. The fold portion 71 has through holes 70 extending from the front side to the back side of the polymer electrolyte member 21.

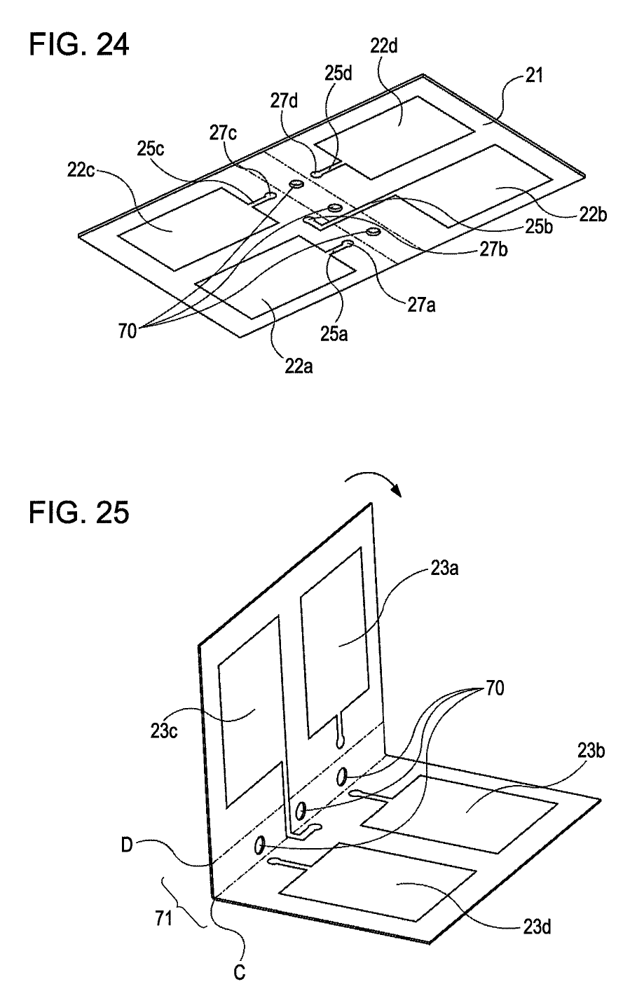

As shown in FIG. 24, fuel electrodes 22a to 22d are formed at the side of the surface of the polymer electrolyte member 21 where the oxidizer electrodes are formed so as to counter the oxidizer electrodes 23a to 23d. From the fuel electrodes 22a to 22d, wiring electrodes 25a to 25d, and contact electrodes 27a to 27d, formed at ends of the wiring electrodes 25a to 25d, are formed towards the fold portion 71 at the center portion of the polymer electrolyte member 21.

At the stage in which the electrodes are formed, the membrane electrode assembly 24 is such that the fuel electrode 22 and the oxidizer electrode 23 of the fuel cell units 3 are not electrically connected to each other.

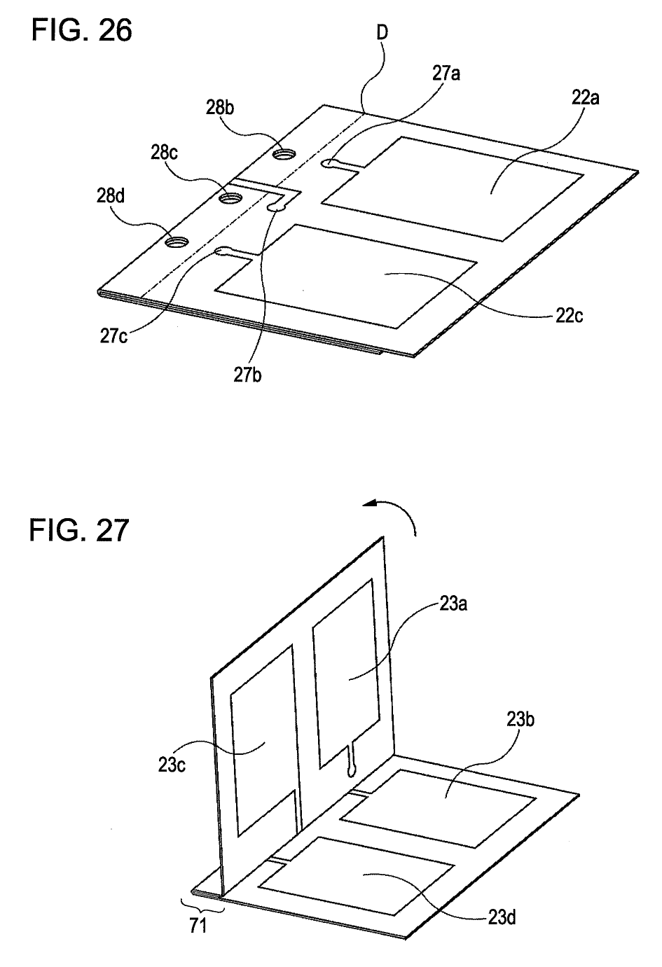

At the next stage, as shown in FIG. 25, with the surface where the contact electrodes 28a to 28d are formed being faced upward, the fold portion 71 at the central portion of the polymer electrolyte member 21 is folded along a first fold line C. By this, as shown in FIG. 26, the contact electrodes 28b to 28d are exposed to the side of the contact electrodes 27a to 27c through the through holes 70, so that the contact electrodes 27 and 28, which are formed on two different sides, are positioned both facing upward.

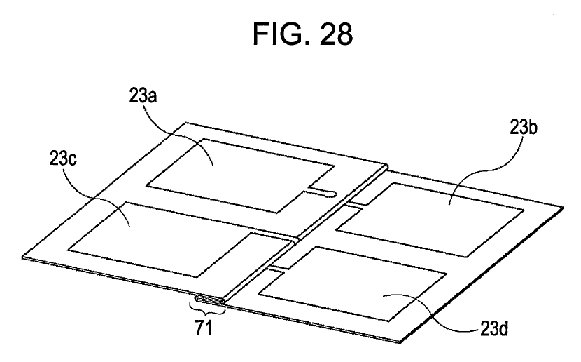

Then, as shown in FIG. 27, the fold portion 71 is folded once again along a second fold line D, so that portions where the contact electrodes 27a to 27c are disposed and the contact electrodes 28b to 28d oppose each other through the through holes 70. As a result, the membrane electrode assembly 24 is finally formed into a state such as that shown in FIG. 28. The contact electrodes are previously patterned and disposed so that, when the contact electrodes 27a and 28b, the contact electrodes 27b and 28c, and the contact electrodes 27c and 28b are folded, they oppose each other at the fold portion 71 through the through holes 70. Therefore, an electrical circuit diagram becomes like that shown in FIG. 12 as in the first embodiment, so that the fuel electrodes 22 and the oxidizer electrodes 23 of the respective fuel cell units 3 are electrically connected in series.

Next, by hot-pressing the fold portion 71, the portions of the polymer electrolyte member 21 that are folded and placed upon each other are joined into an integrated structure, as a result of which leakage of, for example, hydrogen gas from the fold portion does not occur. In addition, at the same time, the contact electrodes 27 and 28 that oppose each other are also welded and joined by hot pressing, so that electrical conduction is stably performed. Accordingly, the membrane electrode assembly 24 in which the fuel electrodes and oxidizer electrodes of the respective fuel cell units 3 are connected to each other in series is completed.

In the first embodiment, the optimal disposing method of reducing the length of a wiring portion when the fuel electrodes and oxidizer electrodes are disposed in series vertically on the respective surfaces of the polymer electrolyte member and parallel to the fold portion is discussed. By virtue of the structure of this embodiment, since the fuel electrodes and the oxidizer electrodes can also be disposed in parallel, the degree of freedom with which the fuel electrodes and the oxidizer electrodes (fuel cell units) of the membrane electrode assembly 24 are disposed can be further increased by disposing the electrodes in parallel or in series.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-344269 filed Dec. 21, 2006, which is hereby incorporated by reference herein in its entirety.

What is claimed is:

1. A membrane electrode assembly comprising:
a common electrolyte membrane having a first surface and a second surface opposite to the first surface; and
a plurality of fuel cell units disposed side by side on the electrolyte membrane,
wherein each fuel cell unit has a first electrode on the first surface and a second electrode on the second surface, and
wherein a first electrode of a first cell is electrically connectable to a second electrode of a second cell as a result of folding or bending an end portion of the electrolyte membrane.

2. The membrane electrode assembly according to claim 1, wherein at least some of the portions of the electrolyte membrane that oppose each other as a result of the folding or the bending are joined to each other.

3. The membrane electrode assembly according to claim 2, wherein the joining is performed by adhesion or welding.

4. A membrane electrode assembly comprising:
a common electrolyte membrane having a first surface and a second surface opposite to the first surface; and
a plurality of fuel cell units disposed side by side on the electrolyte membrane,
wherein each fuel cell unit has a first electrode on the first surface and a second electrode on the second surface,
wherein the electrolyte membrane has a through hole, and
wherein a first electrode of a first cell is electrically connectable through the through hole to a second electrode of a second cell as a result of folding the electrolyte membrane.

5. The membrane electrode assembly according to claim 4, wherein at least some of the portions of the electrolyte membrane that oppose each other as a result of the folding are joined to each other.

6. The membrane electrode assembly according to claim 5, wherein the joining is performed by adhesion or welding.

7. A method of manufacturing a membrane electrode assembly in which a plurality of fuel cell units are disposed side by side on a common electrolyte membrane, the method comprising:
providing each fuel cell unit with a first electrode on a first surface of the electrolyte membrane and a second electrode on a second surface of the electrolyte membrane, opposite to the first surface; and
electrically connecting a first electrode of a first cell and a second electrode of a second cell by folding or bending an end portion of the electrolyte membrane.

8. The method of manufacturing a membrane electrode assembly according to claim 7, wherein at least some of the portions of the electrolyte membrane that oppose each other as a result of the folding or the bending are joined to each other.

9. The method of manufacturing a membrane electrode assembly according to claim 8, wherein the joining is performed by adhesion or welding.

10. A method of manufacturing a membrane electrode assembly in which a plurality of fuel cell units are disposed side by side on a common electrolyte membrane, the method comprising:
providing each fuel cell unit with a first electrode on a first surface of the electrolyte membrane and a second electrode on a second surface of the electrolyte membrane, opposite to the first surface;
forming a through hole in the electrolyte membrane; and
electrically connecting through the through hole, a first electrode of a first cell and a second electrode of a second cell by folding the electrolyte membrane.

11. The method of manufacturing a membrane electrode assembly according to claim 10, wherein at least some of the portions of the electrolyte membrane that oppose each other as a result of the folding are joined to each other.

12. The method of manufacturing a membrane electrode assembly according to claim 11, wherein the joining is performed by adhesion or welding.

13. A fuel cell comprising the membrane electrode assembly according to claim 1, wherein the plurality of fuel cell units are connected in series.

14. A fuel cell comprising the membrane electrode assembly according to claim 4, wherein the plurality of fuel cell units are connected in series.
